(19) United States
(12) Patent Application Publication
(10) Pub. No.: US 2007/0082673 A1
(43) Pub. Date: Apr. 12, 2007

(54) Autonomous mode for a plurality of nested mobile networks

(76) Inventors: Christope Janneteau, Bois D'Arcy (FR); Vidya Narayanan, Schaumburg, IL (US); Alexandru Petrescu, Orsay (FR)

Correspondence Address: MOTOROLA, INC., 1303 EAST ALGONQUIN ROAD, IL01/3RD, SCHAUMBURG, IL, 60196, US

(21) Appl. No.: 11/248,982

(22) Filed: Oct. 12, 2005

(51) Int. Cl. H04Q 7/20

(52) U.S. Cl. 455/445

(57) ABSTRACT

A method for enabling autonomous mode routing between mobile entities in a plurality of nested mobile networks includes the steps of: announcing (305) a root mobile entity address; in response to the announcing, receiving (310) a registration request comprising routing information from each mobile entity in at least a portion of a plurality of mobile entities comprising a plurality of nested mobile networks, wherein at least one of the registration requests is received while in an autonomous mode; and generating (315) a root mobile entity binding cache using the routing information from the registration requests, for enabling routing within the plurality of nested mobile networks.

### FIELD OF THE INVENTION

The present invention relates generally to communication networks and particularly to a centralized approach to enable the support of an autonomous mode for a plurality of nested mobile networks with minimal signaling overhead.

### BACKGROUND OF THE INVENTION

Mobile Internet Protocol (IP) provides IP session continuity for mobile hosts thus offering host mobility support. However, a network mobility support is required for a mobile network, wherein an entire network changes its point of attachment to the Internet (core network). A mobile network can be generally defined as a set of nodes (also referred to herein as Mobile Network Nodes (MNNs)), comprising one or more IP-subnets attached to a Mobile Router (MR), and mobile as a unit with respect to the rest of the Internet.

As a mobile network moves from one IP subnet to another, Network Mobility (NEMO) Basic Support protocol helps maintain continuity of the session of any node of the mobile network. For example, a node forming a part of the mobile network does not experience any discontinuity in the connection when the mobile network, of which it forms a part, is in motion. Such a mobile network could be connected to the rest of the Internet either directly through the MR or through another mobile network, in which case it is termed a nested mobile network. The NEMO protocol relies on an establishment of a bi-directional tunnel between the MR and a Home Agent (HA) associated with the MR to provide the continuity of session to the MNNs behind the MR when the MR is in motion.

When the MR attaches to a visited link, the MR obtains a topologically correct address, called a Care-Of Address (CoA), and registers the CoA to the HA associated with the MR. The MR forwards outgoing IP packets through the tunnel, towards its home network. Similarly, any packet arriving on the MR's home link are intercepted by the HA and forwarded through the tunnel, towards the MR's CoA, if the packet's destination address matches the mobile network prefix (MNP). The MNP comprises a bit string that consists of some number of initial bits of an IP address, which identifies a mobile network within the Internet topology. Generally nodes belonging to the mobile network share the same mobile network prefix. For a single mobile IP-subnet, the MNP is the network identifier of the subnet. The packet routing is achieved by extending the MR's HA to support redirection for the whole MNP, in addition to the MR's home address.

The circuitous path followed by the packet becomes more complex when mobile networks are nested. Nesting of mobile networks could occur when a mobile network attaches to another mobile network, for example a mobile network 2 (for instance connected through a mobile router—MR2) attaches to a mobile network 1 (connected through a mobile router—MR1). In such a case, a packet from a mobile network node MNN2 under MR2 travels to a correspondent node (CN) (a node situated on the main network infrastructure and communicating with a mobile network node behind the MR2) in a much more complex and circuitous path. The path traced is from MNN2 to MR2, then to MRland the home link of MR1, then to the home link of MR2, and finally to the CN on the main network infrastructure. As the level of nesting increases, the complexity in the path increases substantially.

Even when MNN2 and CN are a part of the same plurality of nested mobile networks (for example when two mobile networks are connected to the same network deployed in the plane), the routing path of packets still remains circuitous. This introduces a sub-optimal path between such (neighboring) mobile nodes under the same plurality of nested mobile networks. Further, since the packets have to travel through the main network infrastructure, where the home links are situated, the plurality of nested mobile networks have to be connected to the main network infrastructure at all times. This raises another substantial problem when the plurality of nested mobile networks looses its connection with the main network infrastructure, as two mobile devices under the plurality of nested mobile networks cannot communicate with each other. A shortcoming of the NEMO protocol is that it fails to provide for a connection between the two communicating nodes when the connectivity between the root-MR and the Internet is disconnected.

There are various methods that deal with communication within a plurality of nested mobile networks, but none of them provide a complete solution. These methods can be broadly classified in three categories. A first category provides optimized transmission in the main network infrastructure; however, it does not support an autonomous mode. An autonomous mode provides capability of a mobile network (respectively of an aggregation of nested mobile networks): (1) to maintain any ongoing communication between any two nodes inside this mobile network (respectively inside this aggregation of nested mobile networks); and (2) allows establishment of new communications between any two nodes, in a situation where the mobile router (respectively the root mobile router of the aggregation of nested mobile networks) is disconnected from the Internet. A second category provides optimized transmission within the plurality of nested mobile networks; however it requires the plurality of nested mobile networks to be connected to the main network infrastructure. A third category supports autonomous mode of transmission, under restricted conditions such as where a root MR is the HA of all the nested MRs.

A need therefore arises to implement a centralized method for making it possible for two devices, forming part of a plurality of nested mobile networks, to communicate with each other, even when such plurality of nested mobile networks has lost its connection with the main network infrastructure. Also, as the number of mobile networks in the aggregation increases, the path followed by the packets between the two communicating nodes increases in complexity with an increase in the depth of the two communicating nodes within the plurality of nested mobile networks. Hence there is a further need for providing an optimal path between the two communicating nodes forming part of the plurality of nested mobile networks.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram that indicates generally a plurality of nested mobile networks implementing embodiments of the present invention;

FIG. 2 illustrates a connection between a mobile entity and a neighboring mobile entity forming part of the plurality of nested mobile networks in accordance with embodiments of the present invention;

FIG. 3 illustrates a flow diagram for a method to enable autonomous mode routing between mobile devices forming a plurality of nested mobile networks in accordance with embodiments of the present invention;

FIG. 4 illustrates a flow diagram for a method of routing a packet from a node belonging to a plurality of nested mobile to a destination address in accordance with embodiments of the present invention;

FIG. 5 illustrates a flow diagram of a predetermined method for determining an optimal path between a mobile entity servicing a node that generates a packet and a destination address for the packet in accordance with embodiments of the present invention;

FIG. 6 illustrates a flow diagram depicting the “proactive push” approach for distributing the routing information by the root mobile entity to the other mobile entities in the plurality of nested mobile networks in accordance with embodiments of the present invention;

FIG. 7 illustrates a flow diagram depicting the “reactive push” approach for distributing the routing information by the root mobile entity to the other mobile entities in the plurality of nested mobile networks in accordance with embodiments of the present invention;

FIG. 8 illustrates a flow diagram depicting the “reactive pull” approach for distributing the routing information by the root mobile entity to the other mobile entities in the plurality of nested mobile networks in accordance with the embodiments of the present invention;

FIG. 9 illustrates a flow diagram depicting a method for routing information in a plurality of nested mobile networks in accordance with embodiments of the present invention;

FIG. 10 illustrates a flow diagram depicting a “semi-centralized” approach for distributing the routing information in a plurality of nested mobile networks in accordance with embodiments of the present invention;

FIG. 11 illustrates a flow diagram depicting a method of selecting a root mobile entity belonging to a plurality of root mobile entities within a plurality of nested mobile networks in accordance with embodiments of the present invention;

FIG. 12 illustrates a block diagram of apparatus for executing autonomous mode routing within a plurality of nested mobile networks in accordance with embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus for enabling the support of an autonomous mode for a plurality of nested mobile networks with minimal signaling overhead. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defmed to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of the method and apparatus for enabling the support of an autonomous mode for a plurality of nested mobile networks with minimal signaling overhead described herein. The non-processor circuits may include, but are not limited to, a radio receiver, a radio transmitter, signal drivers, clock circuits, power source circuits, and user input devices. As such, these functions may be interpreted as steps of a method to support an autonomous mode for a plurality of nested mobile networks with minimal signaling overhead described herein. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the present invention discloses a mechanism that provides support for an autonomous mode in a plurality of nested mobile networks. The mechanism also provides an optimal routing path between any two mobile entities in the plurality of nested mobile networks. The invention deals primarily with the system and methodology for discovering, registering, and implementing a routing methodology, on a root mobile entity of a plurality of nested mobile networks, subsequent distribution of routing information to the mobile entities in the plurality of nested mobile networks, and routing using the routing information distributed amongst the mobile entities. Thus, the present invention generally relates to a centralized approach, from the perspective of the root mobile router (root-MR) for implementing the autonomous mode in the plurality of nested mobile networks. The approach typically comprises facilitating communication between any two nodes in the plurality of nested mobile networks when the plurality of nested mobile networks is in the autonomous mode. It also provides optimized routing between any two nodes in the plurality of nested mobile networks when the plurality of nested mobile networks is in the connected mode. Those skilled in the art will realize that the above recognized advantages and other advantages described herein are merely exemplary and are not meant to be a complete rendering of all of the advantages of the various embodiments of the present invention.

The terms used in the present disclosure are explained herein. The explanation has been provided for the sake of clarity and it should not, in any manner, be construed to restrict the meaning of a particular term, and any other term used with it, to the explanation provided herein.

A mobile network can be understood as a set of nodes, comprised of one or more IP-subnets, attached to and served by one or more mobile routers (MRs), and mobile as a unit with respect to the rest of the network or the Internet. A mobile network is also referred to herein as a NEMO.

A mobile network node (MNN) is a node in a mobile network.

A mobile network is said to be nested when the mobile network gets attached to another mobile network. The aggregated hierarchy of mobile networks becomes a single nested mobile network or an aggregation.

A local mobile node (LMN) is a mobile node (MN), either a host or a router, that can move topologically with respect to a mobile router (MR) and whose home link belongs to a mobile network connected through the MR.

A visiting mobile node (VMN) is a mobile node (MN), either a host or a router, that can move topologically with respect to a mobile router (MR) and whose home link doesn't belong to a mobile network connected through the MR. A VMN that gets attached to a foreign link within the mobile network obtains an address on that link, i.e., a Care of Address (CoA).

A mobile network prefix is a bit string that comprises a plurality of initial bits of an IP address, the mobile network prefix identifies a mobile network within an Internet topology. All nodes in a mobile network necessarily have an address containing this prefix.

An ingress interface of a mobile router (MR) is an interface attached to a link inside a mobile network.

A root-MR is a mobile router of a root-NEMO used to connect a nested mobile network to a fixed Internet. The root-NEMO is a mobile network at the top of a hierarchy connecting an aggregated nested mobile network to the Internet.

A parent-MR is a mobile router of a parent-NEMO. The parent-NEMO is an upstream mobile network providing Internet access to a mobile network further down the hierarchy.

A sub-MR is a mobile router of a sub-NEMO connected to a parent-NEMO. A sub-NEMO is a downstream mobile network attached to a mobile network up in the hierarchy. It becomes a subservient of a parent-NEMO. The sub-NEMO gets Internet access through the parent-NEMO and does not provide Internet access to the parent-NEMO.

In respect of a mobile device, a neighboring mobile device is a mobile device that is connected to the mobile device and could be an upstream or a downstream mobile device.

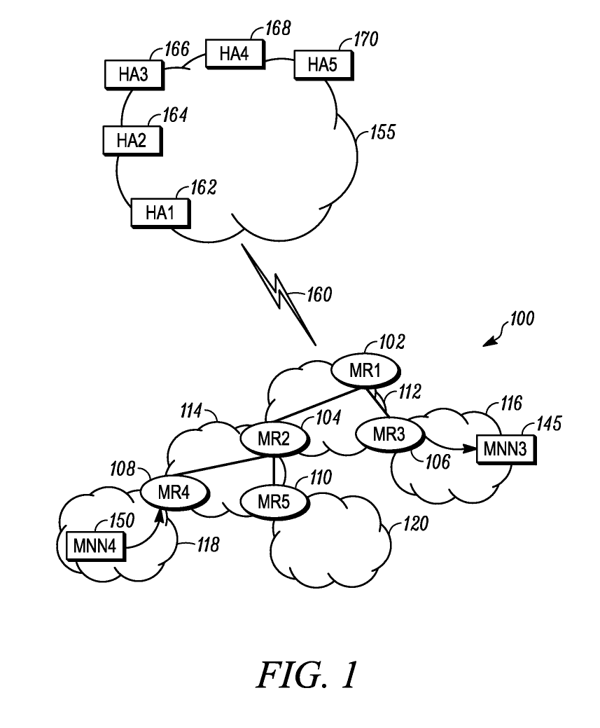

Referring now to the diagrams, and in particular FIG. 1, a block diagram of a plurality of nested mobile networks is shown and indicated generally at 100. The plurality of nested mobile networks 100 is illustrated with five nested mobile networks for clarity of illustration. Those skilled in the art, however, will recognize and appreciate that the specifics of this illustrative example are not specifics of the invention itself and that the teachings set forth herein are applicable in a variety of alternative settings. For example, since the teachings described do not depend on the number of nested mobile networks forming the plurality of nested mobile networks, they can be applied to any number of nested mobile networks in the plurality of nested mobile networks although five nested mobile networks are shown in this embodiment. As such, other alternative implementations of using a different number of nested mobile networks in the plurality of nested mobile networks are contemplated and are within the scope of the various teachings described. Thus, those skilled in the art will realize that a plurality of nested mobile networks may contain many more nested mobile networks or even less than five mobile networks, typically a minimum number being two mobile networks. A nested mobile network may comprise a plurality of fixed entities or nodes (not shown, for clarity of illustration) in addition to a plurality of mobile entities or nodes. A mobile entity could be a mobile router or a mobile host, and any node in a mobile network (either fixed or mobile) is said to be a Mobile Network Node (MNN). Moreover, a nested mobile network is connected through a mobile router (MR) to an aggregation of plurality of nested mobile networks.

Referring again to FIG. 1, an embodiment showing a plurality of nested mobile networks 100 comprises a first mobile network node 150 (MNN4) connected through a first mobile entity 108 (MR4), and a second mobile network node 145 (MNN3) connected through a second mobile entity 106 (MR3), the mobile entities herein being for instance, Mobile Routers (MRs). The first mobile entity 108 connects a first nested mobile network 118 and the second mobile entity 106 connects a second nested mobile network 116. At the top of the plurality of nested mobile networks 100, a root mobile entity 102 (MR1) may connect the plurality of nested mobile networks 100 to a core network infrastructure 155, generally referred to as the Internet. The root mobile entity 102 is at the top of the plurality of nested mobile networks 100 and also connects the first mobile entity 108 to the second mobile entity 106.

As per one embodiment, the first mobile entity 108 can be connected to the root mobile entity 102 through a plurality of mobile entities, such as a third mobile entity 104 (MR2) that connects a mobile network 114. Similarly, the second mobile entity 106 can be connected to the root mobile entity 102 through a plurality of intermediate mobile entities. Apart from the mobile entities that connect the first mobile entity 108 and the second mobile entity 106, the plurality of nested mobile networks 100 could comprise of additional mobile entities, for example a fourth mobile entity 110 (MR5) that connects a mobile network 120). Illustrated is a single root mobile entity for the sake of simplicity. However, those skilled in the art will realize that one or more root mobile entities could be included in the plurality of nested mobile networks without loss of generality. Moreover, as stated earlier, the nesting of mobile networks could go up to any number of nested levels, the nested levels being controlled by hardware and other networking constraints.

For clarity in explanation, the plurality of nested mobile networks, in the embodiment explained herein, comprises five nested mobile networks (112, 114, 116, 118, 120) forming part of the plurality of nested mobile networks. A plurality of home agents 162 (HA1), 164 (HA2), 166 (HA3), 168 (HA4), 170 (HA5) corresponding to the plurality of mobile entities 102, 104, 106, 108, 110 is connected to the core network infrastructure 155. Traditionally, the home agents corresponding to the plurality of mobile entities can manage the routing of the information sent to and from the mobile entities while the mobile entities are roaming in a foreign network. The plurality of nested mobile networks 100 is connected to the core network infrastructure 155 in this embodiment by a wireless link 160.

An embodiment of the invention proposes that each mobile entity (the mobile entities, essentially, being Mobile Routers) in a plurality of nested mobile networks registers with the root mobile entity (root Mobile Router) by sending a Binding Update (BU) mapping the mobile entity's Mobile Network Prefix (MNP) to the mobile entity's care-of Address (CoA) in order to provide a support for the autonomous mode in the plurality of nested mobile networks. The registered mobile entities are then entered in a Binding Cache (BC) at the root mobile entity. The resulting set of BC entries enables the root mobile entity to determine a route from itself to any node in the plurality of nested mobile networks through a set of intermediate mobile entities. When in an autonomous mode, these determined routes enable a mobile entity to tunnel an outgoing packet to the root mobile entity through the upper mobile entities, instead of through its Home Agent (HA). However, those skilled in the art shall appreciate that a scenario exists where a packet from a mobile node within the plurality of nested mobile networks can also be tunneled to the destination mobile node via the HA and such a scenario is within the scope of the present invention. Upon receiving the tunneled packet, the root mobile entity retrieves the inner original packet and, using a recursive parsing of its Binding Cache (BC) for the destination address of the packet, derives an ordered list of care-of addresses of intermediate mobile entities on the path from the root mobile entity to the destination. A successful Binding Cache parsing for the destination implies that the destination is a part of the plurality of nested mobile networks and that the packet can be source-routed along this ordered list of mobile entities' care-of addresses, either by using multiple encapsulations or a Routing Header, to the destination.

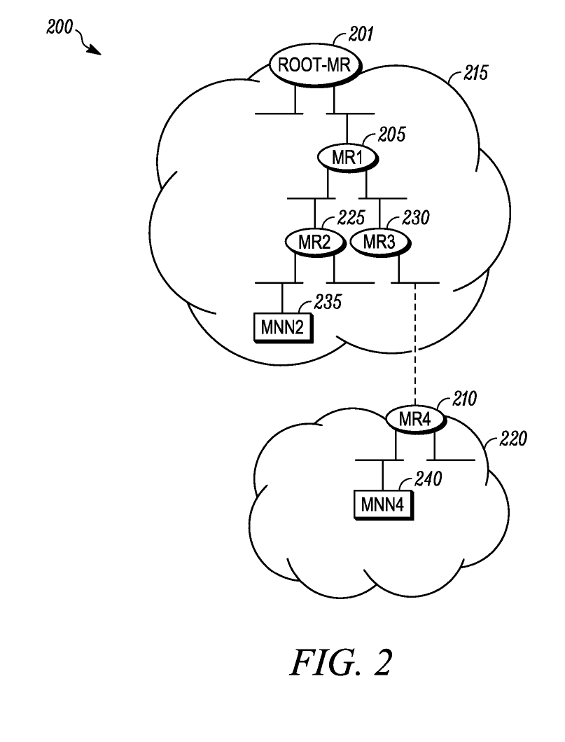

Turning now to FIG. 2 is an embodiment that shows a connection 200 between a mobile entity, for example a mobile router 210 referred to as MR4 forming part of mobile network 220 and a neighboring mobile router 230 referred to as MR3 forming part of an aggregation of nested mobile networks 215. As illustrated, MR4 is nested under mobile router MR3, both MR3 and MR4 forming part of the plurality of nested mobile networks 215, 220. The MR4 210 connects the mobile network 220 to the plurality of nested mobile networks 215 connected through the MR3 230. In this illustration, the plurality of nested mobile networks 215 is a parent NEMO (a root-MR 201 being the root mobile router) to mobile network 220 (and MR4 210 correspondingly a sub-MR), which is a sub-NEMO to mobile network 215. The connection between the mobile entity 210 and the root mobile entity 201 may comprise of a plurality of mobile routers, for example MR1 205, MR3 230. As shown, mobile router MR4 serves a mobile network node MNN4 240 while a mobile router 225 (MR2) serves a mobile network node MNN2 235. Those of ordinary skill in the art would appreciate that the connection could comprise of none, or one or more mobile routers and the embodiment 200 is merely an example to illustrate such a connection, so described for clarity and ease of explanation.

The mobile entity MR4 210 must discover the address of the root mobile entity root-MR 201 in order to establish a connection to the plurality of nested mobile networks 215. For this purpose, a “Root Mobile Router Announcement” (RMRA) option is introduced for a Router Advertisement (RA) message to allow the root mobile entity root-MR 201 to announce its address in the plurality of nested mobile networks 215, 220, for example through the root-MR's ingress interfaces. In one embodiment, the RMRA option comprises at least the root mobile entity address and the next-hop mobile entity address.

The root mobile entity address can either be an address of the root mobile entity's 201 ingress interfaces or the root mobile entity's 201 Home Address or the root mobile entity's 201 Care-of Address. In an exemplary embodiment of the invention, the ingress interface address or the Home Address is assigned as the root mobile entity address. The root mobile entity's 201 Care-of Address is not generally preferred as the root mobile entity 201 may move and correspondingly the Care-of Address may change. Consequently, the other mobile entities MR1 205, MR2 225, MR3 230, and MR4 210 would have to re-send a Binding Update (BU) to the new root mobile entity's address and hence introduces additional overheads.

The next-hop address is the address of the upper mobile entity on the path towards root mobile entity 201. This next-hop address is typically the address of the mobile entity sending the RMRA option to a mobile entity in a given mobile network that is part of the plurality of nested mobile networks. For example for the mobile entity MR4 210, the next-hop address is the address of the mobile entity MR3 230. A mobile entity receiving the RMRA option uses that information for tunneling packets towards root mobile entity 201.

The new mobile entity, MR4 210, assumes it is a root mobile entity by default, for example MR4 selects its root mobile entity address and announces it in the “root mobile entity address” field of the RMRA option, through its ingress interfaces, unless it receives a Router Advertisement (RA) message with a valid RMRA option on at least one of its egress interfaces from for example, the root-MR 201. Those skilled in the art will appreciate that until such time that no RMRA option is received, it implies that the mobile entity has not joined the plurality of nested mobile networks and is, in fact, a root mobile entity for its own network. However, if the RMRA option is received, for example from root-MR 201, the mobile router MR4 detects that the root-MR is a part of the plurality of nested mobile networks 215 and assigns the mobile entity a root-MR status. MR4 then propagates the root mobile entity 201 address from the received RMRA option in its own RMRA options sent through all its ingress interfaces.

Similarly, the root mobile entity 201 places its root mobile entity 201 address in the “next-hop mobile entity address” field of the RMRA option it sends. Alternatively, the root-MR could also leave the field empty indicating that the value is the same as the root mobile entity 201 address field. Any mobile entity below the root mobile entity, such as MR1 205, MR2 225, MR3 230, MR4 210, receiving the RMRA option, will relay the RMRA option in its own Router Advertisements but will change the “next-hop mobile entity address” field to include one of its own ingress interface addresses indicating that the root-MR can be reached via the mobile router's ingress interface. Any fixed router in a mobile network propagates the RMRA option received on an interface into any Router Advertisement (RA) the fixed router sends, so that the option can propagate in the whole mobile network. Fixed routers do not modify the RMRA option, for example they do not change the “next-hop address” field.

The RMRA, thus, enables the mobile entities 205, 230, 225, 210 in the plurality of nested mobile networks 215 to discover the root mobile entity Root-MR 201, the next-hop mobile entity towards the root mobile entity 201 and the egress interface towards this next-hop mobile entity. The egress interface address is the interface on which the RMRA option was received. This information can be used by a mobile entity to route packets upstream towards the root mobile entity. Those skilled in the art will appreciate that the root mobile entity announcement can be implemented through a separate message, instead of through extensions of the Router Advertisement message.

Upon receiving the RMRA option as a part of the RA announcement from root-MR 201, the mobile entity MR4 210 creates a Binding Update (BU) message to the root-MR 201 for binding MR4's Mobile Network Prefix (MNP) 220 to MR4's care-of address (CoA), and tunnels the BU to MR4's next-hop mobile entity, for instance MR3 230 as illustrated, through the MR4's egress interface on which the RMRA option was received. Those skilled in the art will realize that in a situation when there are intermediate mobile entities (MR3 230, MR1 205) on the path to the root mobile entity 201, each of these mobile entities (MR1 205, MR3 230) routes the BU over an IP tunnel to their own next-hop mobile entity on route towards the root-MR. If no fixed router is located in between a mobile entity and its next-hop mobile entity on the route towards the root-MR, the IP tunnel may be skipped and the BU addressed to the root-MR can then be sent directly by the mobile entity to the link layer (e.g. MAC) address of the next-hop mobile entity.

On receiving the BU message, root mobile entity 201 processes the BU message by adding or updating an existing entry in its Binding Cache (BC), and binds the MNP 220 of the mobile entity MR4 210 to its care-of address. The root mobile entity 201, thus, has such a BC for each of the mobile networks under their respective mobile routers in the plurality of nested mobile networks. The entries of the BC provide root mobile entity 201 with a view of the organization of the internal plurality of nested mobile networks, for example which mobile entity is serving which MNP and the connection between the various mobile entities.

If a mobile entity does not receive an RMRA option for a predetermined period of time, for instance a multiple of the RA period, the mobile entity detects that the mobile entity is no longer a part of the plurality of nested mobile networks and, may switch back to the default mode of operation, for instance forwarding outgoing traffic through the Home Agent (HA) corresponding to the mobile entity.

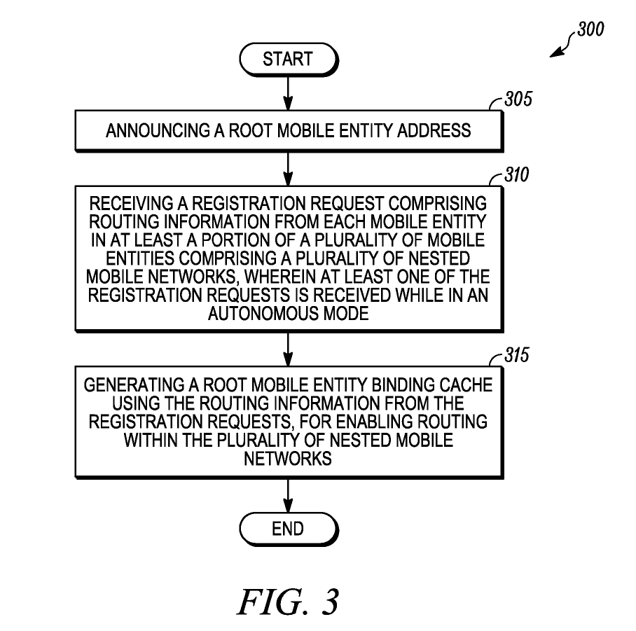

Now, referring to FIG. 3, a flow diagram of a method of enabling autonomous mode routing between mobile devices forming a plurality of nested mobile networks in accordance with embodiments of the present invention is generally depicted at 300. As depicted in step 305, the root mobile entity announces its presence in the plurality of nested mobile networks to enable the mobile entities to discover the root mobile entity as disclosed using FIG. 2. Subsequent to the discovery of the root-MR, the root-MR receives registration requests (that in one embodiment are Binding Updates) comprising routing information from the non-registered mobile entities in the plurality of nested mobile networks, step 310. The routing information comprises at least a care-of address of the mobile entity and a mobile network prefix (MNP) for the mobile entity or a home address for the mobile entity. The registration request can be received while the mobile entity is either connected to the infrastructure or in an autonomous mode, with at least one registration request being received while in the autonomous mode. An autonomous mode, in one embodiment, can be enabled when the mobile routers in a plurality of nested mobile networks exchange packets among each other by obviating the need to route the packet through the home agents of the mobile routers.

To store routing information for later use in the autonomous mode transmission, the root mobile entity generates a root mobile entity Binding Cache (BC) using the routing information received from the registration requests of the mobile entities in the plurality of nested mobile networks, step 315. The BC is typically further updated periodically or based on the BUs received, for example when a mobile entity, like a mobile router, leaves or joins the plurality of nested mobile networks, or moves inside the plurality of nested mobile networks. Those skilled in the art will appreciate that the Binding Cache may not only include the entries for the mobile entities belonging to the plurality of nested mobile networks, but also for other mobile entities attached to the infrastructure, for example if some form of route optimization across the infrastructure is supported.

The root-MR can determine which entries of the Binding Cache (BC) refer to nested mobile networks in the plurality of nested mobile networks, so that only these entries are considered in the routing process of the root mobile entity, which may comprise for example the recursive parsing of the BC. For this purpose, in one embodiment a new Autonomous Mode (AM) flag can be defined that is added to each entry in the root mobile entity's BC. Typically, the AM flag is set to 1 if the entry refers to a mobile network that is a part of the plurality of nested mobile networks serviced by root mobile entity; otherwise it can be set to 0. The value of the AM flag is updated every time a new entry is updated in the BC, for example upon receiving a new Binding Update. Updating may also include creating a new entry in the Binding Cache, in which case the AM flag will be set. Accordingly, a new Autonomous Mode (AM) bit is defined in the Binding Update message. This bit is set to 1 by mobile entities or nodes (mobile routers or mobile hosts) that are sending the Binding Update to their root mobile entity (or one of their root mobile entities, in case there are multiple root mobile entities associated with the plurality of nested mobile networks) that has been detected upon receiving an RMRA option.

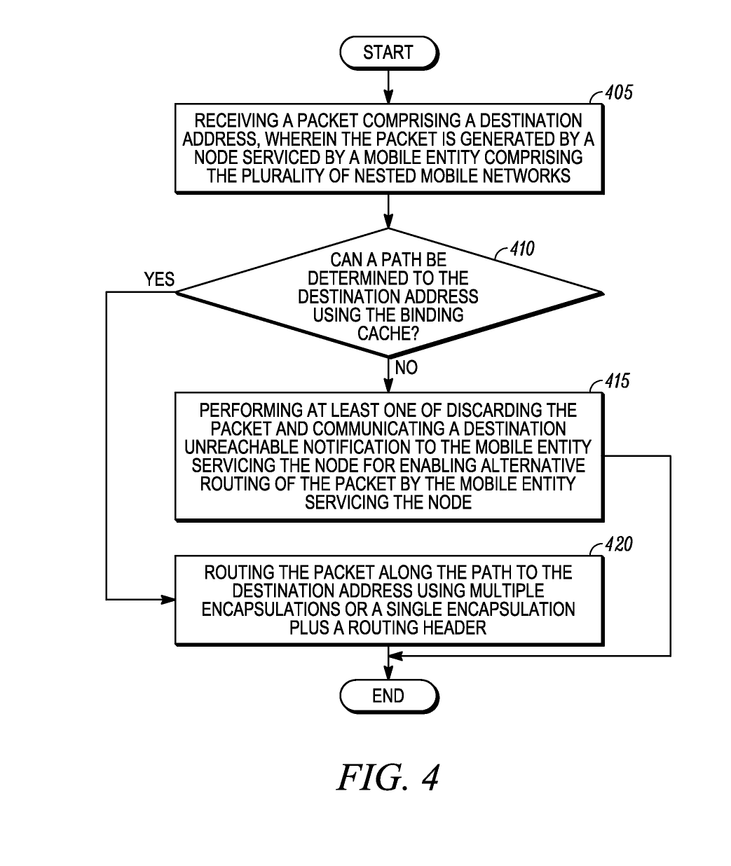

Turning now to FIG. 4, a flow diagram for a method of routing a packet from a node belonging to a plurality of nested mobile networks to a destination address is illustrated in accordance with the embodiments of the present invention. Those skilled in the art will realize that the source node and the destination node could be any of the mobile network nodes in the plurality of nested mobile networks. Any mobile entity in the plurality of nested mobile networks could tunnel an outgoing packet towards the root mobile entity, the root mobile entity having updated its Binding Cache based on the Binding Updates sent by the mobile entities in the plurality of nested mobile networks on a periodic basis. The root-MR provides a centralized approach for routing the packets to the destination node. For ease of depiction, the routing of the packet from a source node to a destination node is illustrated by referring to FIG. 2, where for example a packet has to be routed from the source node MNN4 240 to a destination node (not shown) that is outside the plurality of nested mobile networks.

The root-MR 201 receives the packet comprising the destination address from the mobile entity MR4 210 servicing a node MNN4 240, wherein the packet is generated by the node MNN4 240, step 405. The mobile entity 210 tunnels the packet to root mobile entity 201, by in one embodiment encapsulating the packet first into an IP header with the destination address set to the root mobile entity 201 address, which is known from the RMRA option, and the source address set to an IP address of MR4, for example one of its egress interface addresses. An additional tunnel is also used to forward the packet to the next-hop mobile entity towards root mobile entity 201, which is known from the RMRA option and in this case is MR3 230. The initial packet is thus tunneled twice, first to the root-MR 201 and a second time to the next-hop mobile entity, MR3 230. The second encapsulation between a MR4 210 and MR3 230 is used because a mobile entity may have several upstream mobile entities on the same egress interface, and it would then be possible that the packet addressed to root mobile entity 201 would be routed, along a default route, towards the wrong upstream mobile entity, for example the one which is not the next-hop towards root mobile entity 201.

Those skilled in the art will appreciate that if only a single mobile entity moving network is considered, the second tunneling between a mobile entity and the next-hop mobile entity (together with the next-hop mobile entity address in the RMRA option) can be avoided. Similarly, if there is no fixed router in between a mobile entity and the next-hop mobile entity the second tunneling can also be avoided. In which case, the mobile entity sends the one-time tunneled packet (addressed to the root mobile entity) directly to the link layer (e.g. MAC) address of the next-hop mobile entity.

The doubly tunneled packet is sent through the egress interface of MR4 210 towards the next-hop mobile entity, MR3 230. Subsequent mobile entities including the next-hop mobile entity can remove the first level of encapsulation, and retrieve the inner packet, which is addressed to root mobile entity 201. Using the information contained in the RMRA option it received, the packet is re-tunneled for the root mobile entity 201 towards the next-hop mobile entity. The last mobile entity on the path to root mobile entity, in this case MR1 205, knows that the next-hop mobile entity is actually the root mobile entity 201 and thus may decide not to add the additional header. Accordingly, a packet from a source node MNN4 240 to a destination node is first tunneled to the root mobile entity 201. This tunneled packet is then routed from the mobile entity MR4 210 to root mobile entity 201 over mobile entity-to-next-hop-mobile entity IP tunnels along the path to root mobile entity 201.

Once the root mobile entity 201 receives the packet sent by the mobile entity (mobile router MR4 210 servicing the source node MNN4 240) it extracts the inner initial packet sent by the source node MNN 240. The root mobile entity 201, then, determines (step 410) if the destination address of the packet is a part of the plurality of nested mobile networks in order to determine whether it can route the packet to the destination. The determination process involves a recursive parsing of the Binding Cache in order to find a path from the root mobile entity 201 to the destination address. The path from the root mobile entity to the destination address comprises an ordered list of care-of-addresses of the intermediate mobile entities between the root mobile entity and the destination address. If the root-MR 201 is unable to determine a path to the destination address using the binding cache, for example the destination address is not a part of the plurality of nested mobile networks serviced by the root mobile entity 201, the Root-MR 201 can either discard the packet if the root-MR uses announcement of “Root-MR reachable Prefix” (as explained later) or send a “Destination Unreachable Notification” to the mobile entity MR4 210 servicing the node MNN4 240 for enabling alternative routing of the packet towards the destination address, step 415. The root mobile entity 201 notifies the mobile entity MR4 210 servicing the source MNN4 240 that it should not attempt to route future packets to the destination address through the root mobile entity 201, but instead use an alternate root mobile entity (if several are present) or use the default mode, which could be tunneling the packets to the HA.

While notifying the mobile entity servicing the source node to stop tunneling any packets addressed to an unreachable destination address towards the root mobile entity, the root mobile entity must be able to retrieve the address of the mobile entity servicing the source node of the packet and the root mobile entity must retrieve the path towards this mobile entity corresponding to the source node to be able to send the notification. In an exemplary embodiment of the invention, the retrievals of the address of the mobile entity servicing the source node and the path towards it can be done simultaneously when the root mobile entity uses a method of recursive parsing of its Binding Cache looking for the path from the root-MR to the source node address. The last address in the path is the care-of address of the mobile entity (e.g. mobile router) servicing the source node, and the other addresses of each mobile router on the path form the path from the root mobile entity to the mobile entity servicing the source node. The root-MR then uses either multiple encapsulations or a Routing Header to route the notification, addressed to the mobile entity servicing the source, along the identified path from root mobile entity to the mobile entity servicing the source.

The mobile entity keeps a track of the notification messages it receives from the root-MR, so that it stops forwarding traffic to the specified destination address toward the root mobile entity, but instead uses an alternate root mobile entity or a default routing mechanism. In one embodiment, the mobile entity can stop forwarding traffic to the specified destination address for a specific period of time, and then perform periodic checks to determine if the destination address is reachable. In addition, to enable the storage of information received from the notification message, a structure called Autonomous Mode Destination Unreachable Cache (AMDUC) is introduced. The AMDUC comprises a list of the destination addresses that are unreachable (ideally together with a lifetime associated with each address) for each root mobile entity. The lifetime is generally set to a default value when the address is placed in the AMDUC, or is set to a value that may be indicated in the received notification message. The address is removed from the AMDUC when the lifetime expires. This allows the mobile entity to periodically re-attempt a route optimization via the root mobile entity that may become possible in case the destination address has joined the plurality of nested mobile networks.

As per one embodiment of the invention, the root mobile entity can announce a list of all the prefixes of moving networks that are a part of the plurality of nested mobile networks, together with its own moving network prefix. These prefixes are known from the entries available in the Binding Cache of the root mobile entity. This embodiment involves using an extra field called the “reachable prefix list” in the RMRA option to announce the list of the reachable prefixes. An alternate embodiment could use a separate message to announce the reachable prefixes. The “reachable prefix list” is set by the root-MR and relayed by other nested mobile entities in their individual RMRA option. The root-MR updates the “reachable prefix list” announced in the plurality of nested mobile networks as new prefix entries in the binding cache appear or when some entries expire.

For example, the root mobile entity updates its “reachable prefix list” if a new mobile entity joins the plurality of nested mobile networks or if a mobile entity leaves the plurality of nested mobile networks or if the lifetime of a binding update of a mobile entity expires. Using this “reachable prefix list” information in the RMRA option, any mobile entity in the plurality of nested mobile networks knows the root mobile entity address, the next-hop mobile entity towards the root mobile entity, the egress interface towards this next-hop mobile entity (the interface on which the RMRA option was received), and the list of prefixes reachable through root mobile entity provided by the “reachable prefix list”. Thus, any mobile entity in the plurality of nested mobile networks can determine whether it should tunnel a packet addressed to a given destination address towards root mobile entity or not, depending on whether the destination address matches one of the entries in the reachable prefix list.

If, from the recursive parsing of the binding cache at the root mobile entity, no path is found to the destination address, but if the destination address matches the root mobile entity's 201 mobile network prefix, the root mobile entity 201 natively routes the packet to the destination through the root mobile entity's ingress interface indicated in the root mobile entity's routing table.

If however, from the recursive parsing of the binding cache at the root mobile entity, a path is found from the root mobile entity 201 to the destination address, for example at least one intermediate care-of addresses is found, the packet is routed towards the destination along this path using either multiple encapsulations of the original packet or a single encapsulation plus a routing header, step 420._{[a1]} As per one embodiment, while performing multiple encapsulations, the original packet is encapsulated ‘n’ times into ‘n’ different IP headers, where ‘n’ is the number of intermediate addresses on the path. In the situation depicted in FIG. 2, if a packet is to be sent from the node MNN4 240 to a destination address MNN2 235, ‘n’ can be 2 since there are two intermediate mobile entities MR1 and MR2, between the root mobile entity 201 and the destination node 235. All the IP headers have the root-MR 201 as the source address. The destination addresses in these different IP headers are sorted in the order from the uppermost to the innermost encapsulation, for example in the same order as the path computed with the IP header of MR1 205 encapsulating the IP header of MR2 225. In single encapsulation, the original packet is encapsulated in a single IP packet equipped with a routing header. The source of the encapsulating header is the root mobile entity 201 address and the destination is set to the first intermediate care-of address in the path, and the rest of the ordered list of care-of addresses forming the path are placed in the routing header.

As per one embodiment of the invention, a node generating a packet can route it to a reachable destination address via an optimal path, wherein the optimal path might not include the root mobile entity. This optimal path is calculated at either a mobile entity or a root mobile entity using a predetermined methodology.

In one embodiment of the invention, the root mobile entity generates a Autonomous Mode Binding Cache (AMBC) using information from its Binding Cache (BC). The AMBC generally comprises all the entries of the binding cache that relates to mobile entities which are part of the plurality of nested mobile networks under the root mobile entity. Where the root mobile entity's Binding Cache contains some entries for mobile entities that are not a part of the plurality of nested mobile networks under the root mobile entity, the root mobile entity can use the AM flag to distinguish between mobile entities that are a part of the plurality of nested mobile entities and those that are not. Accordingly, the flag can be set to 1 only for entries that are a part of the plurality of nested mobile networks. Thus, all entries of the BC with AM flag set to 1 are selected as AMBC entries.

Each entry in the AMBC includes the mobile network prefix (or just a home address in case of a single mobile node) of a mobile entity in the nested mobile networks, its care-of address, a lifetime (all three fields copied of the associated BC entry) and in addition also includes an ingress interface address of the mobile entity. In addition to these entries derived from the BC, the root mobile entity can add another AMBC entry for its own mobile network prefix (root-MNP). The additional AMBC entry includes at least the root mobile entity's MNP, the root mobile entity's ingress address, the root mobile entity's care-of address and a lifetime, set to a default value. The AMBC is ideally updated as changes to the BC are made, typically upon receiving Binding Updates. Each mobile entity in the plurality of nested mobile networks under the root mobile device includes its ingress interface address inside the Binding Update message it sends to the root mobile device, so that this information can be included in the AMBC of the root mobile device. This can be implemented for instance with a new “Mobile Router Ingress Address” (MRIA) option in the Binding Update message.

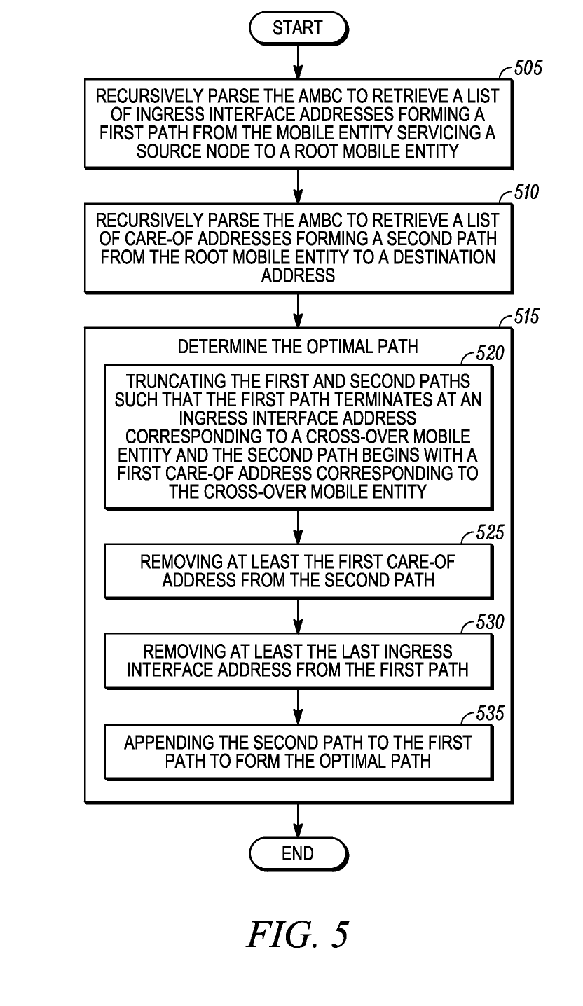

Turning now to FIG. 5, a flow diagram illustrating a predetermined method for calculating an optimal path between a mobile entity servicing a source node that generates a packet and a destination address for the packet is shown in accordance with the embodiments of the present invention. The path followed by the packet while traveling from a mobile entity (mobile router) servicing the node to a root mobile entity consists of ingress addresses of the intermediate mobile entities between the mobile router servicing the node and the root-MR, whereas, the path followed by the packet while traveling from the root-MR to a destination address consists of the care-of addresses of the intermediate mobile entities between the root-MR and the destination address.

According to the predetermined method, the Autonomous Mode Binding Cache is recursively parsed to retrieve a list of ingress interface addresses forming a first path from the mobile router servicing the node that generates the packet to the root-MR, step 505. For example, referring back to FIG. 2, where node MNN4 240 is the source node for a packet with MR4 210 servicing MNN4 240 and the destination for the packet is MNN2 235 with MR2 225 servicing MNN2 235, the first path from MR4 210 to the root-MR 201 will consist of the ingress addresses of MR4 210, MR3 230, MR1 205 and the root-MR 201 in that order. The Autonomous Mode Binding Cache is again recursively parsed to retrieve a list of care-of addresses forming a second path from the root-MR to the destination address, step 510. For example, the second path from the Root-MR 201 to MNN2 235 will consist of the care-of addresses of the mobile entities Root-MR 201, MR1 205 and MR2 225. Based on the first and second paths, an optimal path is determined, step 515.

In one embodiment, the optimal path is determined by truncating the first and second paths such that the first path terminates at an ingress interface address of a cross-over mobile entity (a mobile entity where the first and the second paths intersect, for example MR1 205 in FIG. 2) belonging to the plurality of nested mobile networks and the second path begins with the care-of address of the cross-over mobile entity, step 520. The path is then truncated by removing the first care-of address from the second path, step 525, and removing the first ingress interface address from the first path, step 530. While performing the truncation, the root-MR's 201 care-of address and the MR1's 205 (cross over mobile entity) care-of address are removed from the second path altering the second path route to comprise the care-of address of MR2 225. Similarly, the root-MR 201 ingress interface address and the MR4's 210 (servicing mobile entity) ingress interface address are removed from the first path altering the first path route to comprise the ingress interface addresses of MR3 230, MR1 205. The optimal path can be determined by appending the first path and the second path, step 535. As illustrated in FIG. 2, the optimal path from the mobile entity MR4 210 servicing the source node MNN4 240 to the destination MNN2 225 comprises MR3 230 ingress address, MR1 205 ingress address, and MR2 225 care-of address.

Generally, to avoid having to re-compute the optimal path for similar source and destination nodes, the optimal path can be stored for as long as the AMBC used to compute the optimal path is being utilized. The optimal path is ideally the shortest path from the mobile entity servicing the source node to the destination address. As per one embodiment of the invention, four routing information distribution approaches can be used for routing the packets along the optimal path, e.g., a proactive push approach, a reactive push approach, a reactive pull approach and a semi-centralized approach, each of which is described below in detail. The first three approaches rely on the distribution of routing information from the root mobile entity to other mobile entities in the plurality of nested mobile networks. They rely on the use of the AMBC as well. The last one does not involve any distribution of routing information from the root mobile device and does not rely on the use of the AMBC (e.g., the “ingress interface” field is not needed).

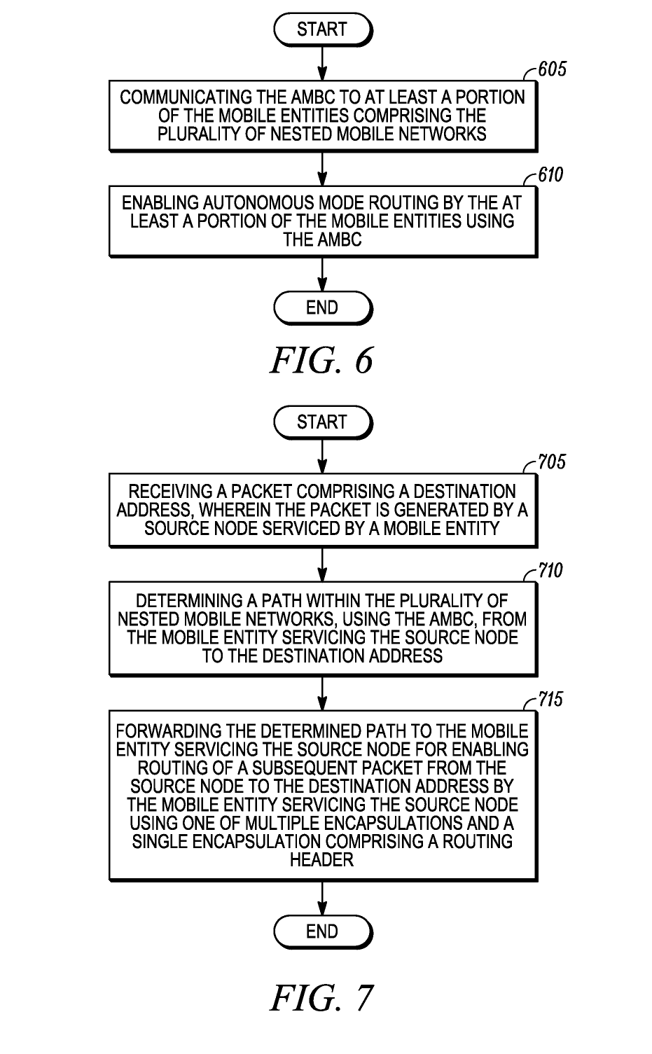

Turning now to FIG. 6, a flow diagram illustrating a “proactive push” approach for distributing routing information by the root mobile entity to the other mobile entities in the plurality of nested mobile networks is shown in accordance with the embodiments of the present invention. During the “proactive push” approach the root-MR communicates its autonomous mode binding cache to at least a portion of the mobile entities in the plurality of nested mobile networks, step 605.

The Autonomous Mode Binding Cache sent by the root mobile entity enables each of the mobile entities in the plurality of nested mobile networks that receives it to maintain a copy of this AMBC. The AMBC contains an entry for each mobile network in an aggregation tree serviced by a root mobile entity, including the root mobile entity's own mobile network. An aggregation tree is the plurality of nested mobile networks which is serviced by a given root mobile router. Thus, where more than one root mobile router services a given plurality of nested mobile networks, it can be said that there are multiple aggregation trees, wherein a separate AMBC is associated with each aggregation tree in the multiplicity of aggregation trees. Each entry includes at least a mobile entity's mobile network prefix (MNP), a mobile entity's ingress interface, a mobile entity's care-of address and a lifetime. A new AMBC option for each of the AMBC entries of the root mobile entity is sent to the mobile entities along with the Binding Acknowledgement (BA) when the mobile entities send a Binding Update. An AMBC Refresh message is sent to all the nested mobile entities in the plurality of nested mobile networks if an AMBC entry changes. Changes may include a new entry being added (for example a new mobile entity joins the plurality of nested mobile networks), an existing entry being updated (for example a lifetime update, change of care-of address, etc) or an entry that has been explicitly removed (for example receiving a BU with a lifetime set to zero).

In one embodiment of the present invention, the AMBC Refresh message is implemented as a new type of Mobility Header. Another embodiment of the invention includes the root mobile entity aggregating several AMBC options in a single AMBC Refresh message in order to minimize signaling, for example when several AMBC entries are modified during a short time interval. In yet another embodiment of the invention, the root mobile entity waits for a certain amount of time before sending the AMBC Refresh in order to aggregate the changes. It could also send an AMBC Refresh only periodically, where each message aggregates the AMBC changes during the past period. Alternatively, the AMBC Refresh could be implemented by extending the “root-MR reachable prefix” announcement in order to broadcast or multicast AMBC Refresh messages instead of sending a copy to each mobile entity. In case of multiple aggregation trees, the mobile entities will have AMBC for each of the root mobile entities that will be updated regularly. A mobile entity servicing a source node may, thereby, compute an optimal path from itself to a destination address using its AMBC according to the predetermined algorithm described in FIG. 5.

Once the optimal path is computed at the mobile entity, a packet is routed along this path using multiple encapsulations or single encapsulation along with a routing header, thus enabling autonomous mode routing by the portion of the mobile entities using the autonomous mode binding cache, step 610. There could, however, be a possibility that the subsequent mobile entities on the route may again compute an optimal path for the packet. To avoid this, a new Root Mobile Router Address (RMRA) Destination option including the address of the root mobile entity corresponding to the AMBC used for determining the route is placed in the packet. The RMRA Destination option is placed before the Routing Header if single encapsulation along with a routing header is used so that it is visible to all intermediate mobile entities along the route. When receiving a packet with the RMRA Destination option, the subsequent mobile entity in the route just forwards the packet to the next mobile entity, after processing the routing header without attempting to compute an optimal path (based on the AMBC) for the packet, so that the packet can eventually reach the destination address. The inclusion of the root mobile device address in the RMRA Destination option is optional. It can be used by an intermediate mobile entity along the route to determine which egress interface the packet should be forwarded through in order to reach the next-hop (if the next-hop address does not match the intermediate mobile entity's prefix in which case the packet would be sent through the ingress interface). This inclusion is optional since the intermediate mobile entity may have other means (e.g. its routing table) to do this determination.

Turning now to FIG. 7, a flow diagram illustrating the “reactive push” approach for distributing the routing information by the root mobile entity to the other mobile entities in the plurality of nested mobile networks is shown in accordance with embodiments of the present invention. In the Reactive Push approach, a mobile entity in the plurality of nested mobile networks maintains a cache containing the optimal route from the mobile entity towards a destination address. The cache is called an Autonomous Mode Source Route Cache (AMSRC). An entry in the AMSRC contains a destination address, the optimal route towards the destination address and a lifetime value. The root mobile entity may send AMSR Refresh message to a mobile entity in the plurality of nested mobile networks to be used by the mobile entity to update its AMSRC with the information included in the message.

In the Reactive Push Mode, a mobile entity servicing a source of a packet, that has to be sent to a destination address, tunnels the packet towards the root mobile entity and is received at the root mobile entity, at step 705. Upon receiving the tunneled packet, the root mobile entity itself computes the optimal path from the mobile entity servicing the source to the destination address using its Autonomous Mode Binding Cache, step 710, according to the predetermined method described in FIG. 5. The root mobile entity sends the computed optimal path associated with the destination along with a lifetime to the mobile entity servicing the source using an AMSR Refresh message. The association between the destination address and the path will be stored in the mobile entity's AMSRC, thereby enabling routing of a subsequent packet from the node to the destination address by the mobile entity servicing the node using one of multiple encapsulations and a single encapsulation comprising a routing header, step 715.

Due to some mobile entities leaving the plurality of nested mobile networks, some entries in a mobile entity's AMSRC may become obsolete after a time interval. As per one embodiment of the invention, a Destination Unreachable Notification is sent to the mobile entity servicing the source node by an intermediate mobile entity in the route that is unable to route the packet further. Upon receipt of the notification, the AMRSC entry corresponding to the unreachable route is discarded. As per one embodiment of the present invention, a reverse route from the mobile entity servicing the destination address to the source address is computed by the root mobile entity according to the predetermined method described in FIG. 5. This reverse route is then sent to the mobile entity servicing the destination. Sending the reverse route to the mobile entity substantially reduces the time needed to send reverse packet from the destination to the source along an optimized path.

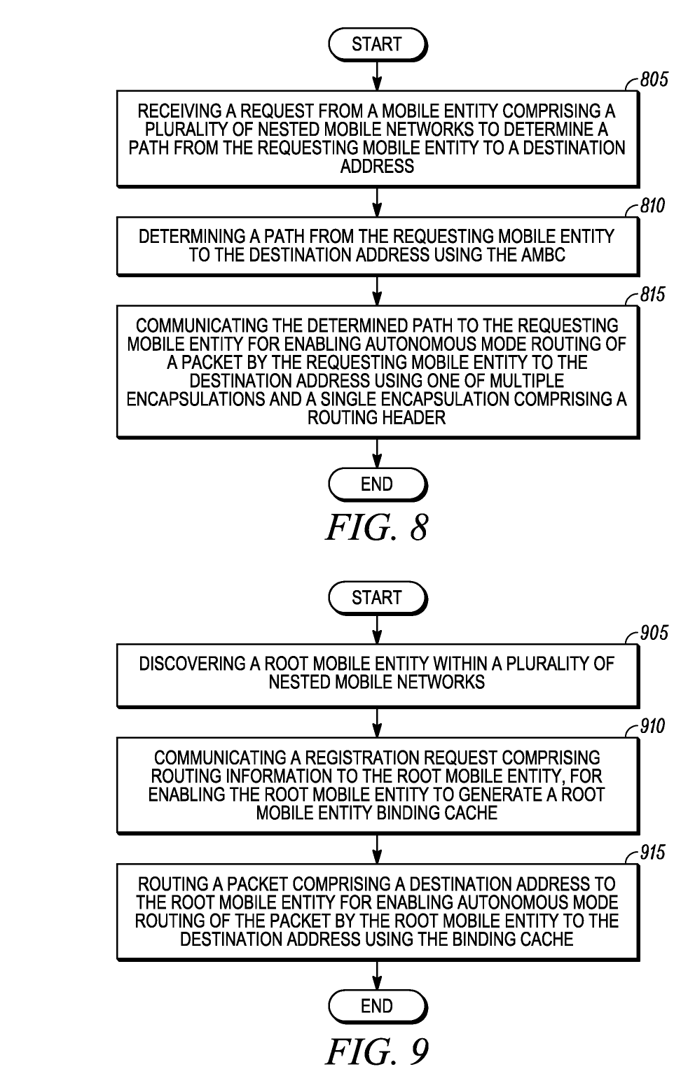

Turning now to FIG. 8, a flow diagram depicting the “reactive pull” approach for distributing routing information by the root mobile entity to the other mobile entities in the plurality of nested mobile networks is shown in accordance with embodiments of the present invention. In the Reactive Pull approach, the root mobile entity receives a new AMSR Request message from a mobile entity servicing a source node to determine a path, ideally an optimal path, towards a destination address, step 805. The root mobile entity, then, determines a path, ideally an optimal path, from the requesting mobile entity to the destination address using its autonomous mode binding cache, step 810, according to the predetermined method described in FIG. 5 and communicates the determined path to the requesting mobile entity for enabling autonomous mode routing of a packet by the requesting mobile entity to the destination address using one of multiple encapsulation and a single encapsulation comprising a routing header, step 815. The request message sent by the mobile entity in step 805 is an AMSR request message, requesting the root mobile entity to send an AMSR Refresh message. In response to the AMSR request message, the root mobile entity determines the path and sends it to the requesting mobile entity in an AMSR Refresh message. Thus, the determination is done by the root mobile entity only when a mobile entity in the plurality of nested mobile networks requests the root mobile entity for a path towards a destination address.

Turning now to FIG. 9, a flow diagram illustrating a centralized approach for routing packets in the plurality of nested mobile networks is shown in accordance with embodiments of the present invention. A mobile entity, for instance a mobile node or a mobile router servicing the mobile node, discovers a root mobile entity within a plurality of nested mobile networks, step 905. Upon discovering the root mobile entity, the mobile entity servicing the node communicates a registration request (e.g., a Binding Update) comprising routing information to the root mobile entity, for enabling the root mobile entity to generate a root mobile entity binding cache, step 910. The routing information comprising each registration request comprises at least a care-of address and a mobile network prefix if the mobile entity is a mobile router (MR) and care-of address and a home address if the mobile entity is a mobile node (MN). The mobile entity servicing the node then routes the packet comprising a destination address to the root mobile entity for enabling autonomous mode routing of the packet by the root mobile entity to the destination address using its binding cache, step 915.

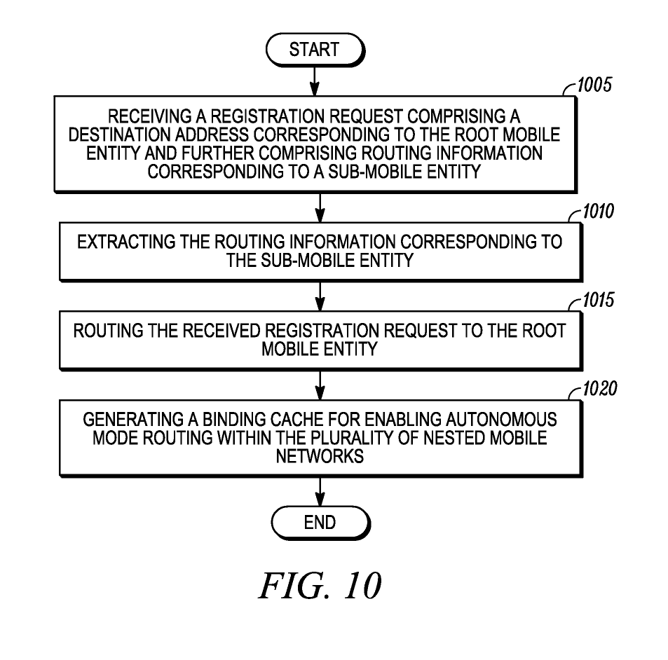

Turning now to FIG. 10, a flow diagram illustrating a semi centralized approach for distributing the routing information in at least a portion of the plurality of nested mobile networks is shown in accordance with the embodiments of the present invention. A Semi Centralized approach is used for further optimizing the routing procedure within the plurality of nested mobile networks. Each mobile entity belonging to the plurality of nested mobile networks gets a view of the topology behind itself. More precisely, each mobile entity in the plurality of nested mobile networks will know all the mobile entities (and their prefixes) which are nested under itself. This is achieved by enabling the intermediate mobile entities on the path from a mobile entity to the root mobile entity to get the mobile entity's Binding Update (mapping its prefix to its CoA) as the mobile entity sends the Binding Update to the root mobile entity.

In one embodiment, each intermediate mobile router in the path from a sub-mobile entity (mobile node or mobile router) to the root-MR receives the registration request (e.g. Binding Update) from the sub-mobile entity comprising a destination address corresponding to the root-MR and further comprising routing information corresponding to the sub-mobile entity, step 1005. As mentioned earlier, a sub-mobile entity can be a sub-MR, for example a mobile router of a sub-NEMO. The routing information corresponding to the sub-mobile entity is extracted by each intermediate mobile router, step 1010. After extracting the routing information, the received registration request is routed to the root-MR, step 1015. The intermediate mobile routers generate a second binding cache for enabling autonomous mode routing within the plurality of nested mobile networks (sub-NEMO), step 1020. Hence each intermediate mobile router on the path from the sub-mobile entity to the root-MR has created or updated a binding cache entry for the said sub mobile entity, the entry including at least the sub-mobile entity prefix and care-of address if the sub-mobile entity is a mobile router and a home address and a care-of address if the sub-mobile entity is a mobile node.

The binding cache built at each mobile router in the plurality of nested mobile networks contains an entry for each sub-mobile entity (mobile node or mobile network) under the mobile router, and is used by the mobile router to route any packet along an optimized path inside the plurality of nested mobile networks. A mobile router that needs to route a packet addressed to a given destination address will forward the packet directly to the destination if the destination address matches the mobile router's prefix. If not, the mobile router will use its binding cache to determine if the destination address belongs to the set of nested mobile entities under itself, e.g., if the destination address matches one of the entries in its binding cache. If this is the case, the mobile router can route the packet downstream to the destination using one of two ways.

In a first embodiment, the mobile router computes an optimized path from itself to the destination address using a recursive parsing of its binding cache and routes the packet along this path using one of multiple encapsulations or a single encapsulation along with a routing header. In an alternative embodiment, the mobile router only forwards the packet to the next hop mobile router on the downstream path to the destination (typically using an IP tunnel), and the next hop mobile router can route the packet based on its own binding cache. Finally, if the destination address does not match the mobile router binding cache, the mobile router can forward the packet upstream towards the next hop mobile router on the path to the root-MR.

As per one embodiment of the invention, there could be a scenario where a mobile router has multiple egress interfaces, and as a consequence, can be connected to multiple upstream root-MRs. There may also be scenarios when a mobile network is serviced by several mobile routers, where each of then is connected to a different upstream root-MR. Generally, a mobile network equipped with multiple egress interfaces, as well as any other mobile network attached to it, can potentially be part of multiple aggregation trees serviced by different root mobile entities.

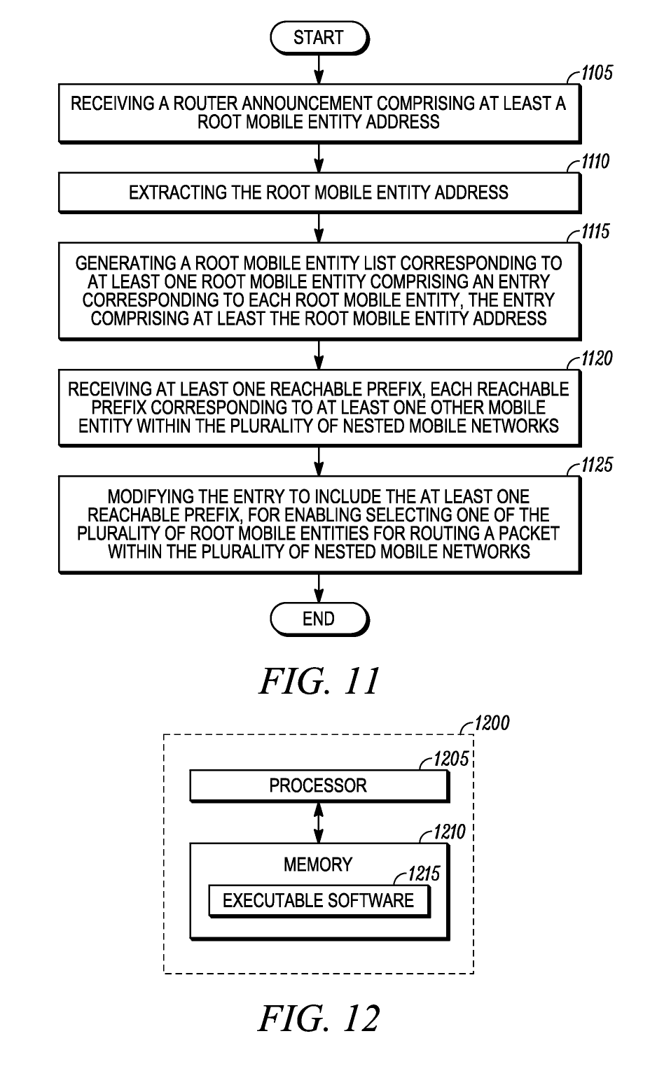

Referring to FIG. 11, a flow diagram illustrating a method of selecting a root mobile entity belonging to a plurality of root mobile entities within a plurality of nested mobile networks is shown in accordance with embodiments of the present invention. To discover the addresses of the different root-MR's, the invention allows a mobile entity, for instance a mobile router, to include several RMRA options in the Router Advertisements (RA) it sends on its ingress interfaces, to advertise all of the RMRA options it receives on its egress interfaces. Thus, the mobile entities belonging to the plurality of nested mobile networks receive an RA comprising at least a root mobile entity address within the plurality of nested mobile networks, step 1105. The upstream RMRA options may be received through different mobile entity egress interfaces, or through the same mobile entity ingress interface but in RA messages from different upstream mobile entities, or through the same mobile entity ingress interface and in the same RA message.

Upon receiving the RMRA options, the mobile entities extract the root mobile entities' addresses, step 1110. The mobile entities, then, generate a root mobile entity list (also referred to herein as a Root Mobile Router List (RMR List)) corresponding to the plurality of root mobile entities. An entry corresponding to each root mobile entity is generally included in the RMR List, step 1115. Each entry in the RMR list typically includes at least the root mobile entity address, and also ideally the next-hop mobile entity address, the mobile entity's egress interface towards this next-hop mobile entity and a lifetime associated with the entry which is refreshed each time a new RMRA option for root mobile entity is received. The egress interface towards the next-hop mobile entity is the one through which the RMRA option for the root mobile entity has been received.

In one embodiment, if a “Root-MR Reachable Prefix” announcement is used, the entry could also contain a reachable prefix list for the root mobile entity comprising at least one reachable prefix corresponding to at least one other mobile entity within the plurality of nested mobile networks, step 1120. The original root mobile entity entry can be modified to include the at least one reachable prefix, for enabling selecting one of the plurality of root mobile entities for routing a packet within the plurality of nested mobile networks, step 1125. Depending on the topology of the plurality of nested mobile networks, it may happen that several RMRA options for the same root mobile entity and with different next-hop mobile entity's are received by a given mobile entity. This problem could be dealt with, for instance, by pre-configuring an ordered list of preferred next-hop mobile entity, or a priority flag set in the RMRA option.

A mobile entity, belonging to multiple aggregation trees, will send a BU to each of its root mobile entities through their ingress interfaces. Upon sending the BUs to each root mobile entity, the mobile entity's MNP will bind to the care-of address configured on the egress interface. When a mobile entity needs to route an outgoing packet, it determines which of these root mobile entities can be used to send the packet. The routing methodology implemented by the mobile entity can be a simple generalization of the mobile entity routing of packets towards the root mobile entity as described earlier and may depend on the AMDUC or on the “reachable prefix list”, if the later option is used.

For routing packets to a root mobile entity belonging to a plurality of root mobile entities, a mobile entity servicing the source of the packet first checks if the mobile entity RMR list is empty. If the list is empty, it routes the packet according to the default mode, for example it tunnels the packet through its Home Agent (HA). If the RMR list is non-empty (it has at least one entry), then the mobile entity checks if the destination address is the same as one of the root mobile entities listed in the RMR list. If the destination address matches one of the root mobile entity addresses on the RMR list, the mobile entity tunnels the packet to the next-hop address towards that root mobile entity through mobile entity's egress interface associated to the root mobile entity in the RMR list. If the destination address does not match any of the root mobile entity addresses on the RMR list, then the mobile entity can select the first root mobile entity in the RMR list as its root mobile entity.

The mobile entity now checks if the destination address is listed in the AMDUC (Autonomous Mode Destination Unreachable Cache) for the root mobile entity, in case “reachable root-MR prefix” is not used by the root mobile entities. If the destination address is found in the AMDUC, then the corresponding root mobile entity cannot be used to route the packet to the destination address, and the mobile entity will select the next root mobile entity in the RMR list to determine if it can be used for the destination address. The mobile entity continues doing this until all the root mobile entities in the RMR list have been exhausted. During the process, if the mobile entity finds the destination address not listed in the AMDUC of a root mobile entity, it tunnels the packet for the destination address to that root mobile entity. The packet is now tunneled to the next-hop address towards the root mobile entity through the egress interface associated to that root mobile entity in the RMR list. If all the root mobile entities have been tested, the mobile entity routes the packet according to the default mode.

If the “Root-MR reachable prefix” is used by the root mobile entities, the mobile entity checks for the destination address in the “root-MR reachable prefix” of each root mobile entity listed in its RMR list, instead of using the AMDUC. The mobile entity routes the packet towards the root mobile entity whose “Root-MR reachable prefix” includes the destination address using the same procedure described above. If no such root mobile entity is found, the mobile entity routes the packet according to the default mode, for example via its Home Agent.

Referring to FIG. 12, a block diagram of the apparatus 1200 to execute autonomous mode routing within the plurality of nested mobile networks is illustrated in accordance with embodiments of the present invention. The apparatus 1200 broadly comprises a processor 1205 coupled to a memory 1210. An executable software 1215, programmed to enable autonomous mode routing in the plurality of nested mobile networks, is stored in the memory 1210. The software is programmed to announce the root mobile entity in the plurality of nested mobile networks, and subsequently receive registration requests from various mobile entities to join the plurality of nested mobile networks. The root mobile entity then generates a Binding Cache using the received registration requests. Those skilled in the art will appreciate that the software can reside on any or all of the mobile entities that are a part of the plurality of nested mobile networks since any mobile entity can be a root mobile entity in a plurality of nested mobile networks such that the autonomous mode for routing is enabled.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defmed solely by the appended claims including any amendments made during the pendency of this application and all equivalents of those claims as issued.

What is claimed is:

1. A method for enabling routing comprising the steps of:
announcing a root mobile entity address;
in response to the announcing, receiving a registration request comprising routing information from each mobile entity in at least a portion of a plurality of mobile entities comprising a plurality of nested mobile networks, wherein at least one of the registration requests is received while in an autonomous mode; and
generating a root mobile entity binding cache using the routing information from the registration requests, for enabling routing within the plurality of nested mobile networks.

2. The method of claim 1 further comprising the steps of:
receiving a packet comprising a destination address;
determining a path within the plurality of nested mobile networks to the destination address using the binding cache; and
routing the packet to the destination address using the determined path.

3. The method of claim 2, wherein the packet is generated by a node serviced by a mobile entity comprising the plurality of nested mobile networks, the method further comprising the steps of:
determining a second path within the plurality of nested mobile networks, using the binding cache, from the mobile entity servicing the node to the destination address; and
forwarding the determined second path to the mobile entity servicing the node for enabling routing of a subsequent packet from the node to the destination address by the mobile entity servicing the node using one of multiple encapsulation and a single encapsulation comprising a routing header.

4. The method of claim 2, wherein the packet is routed using one of multiple encapsulation and a single encapsulation comprising a routing header.

5. The method of claim 2, wherein the path is an optimal path determined based on a predetermined method.

6. The method of claim 5, wherein:
the packet is generated by a node serviced by a mobile entity comprising the plurality of nested mobile networks;
the binding cache comprises an entry corresponding to each mobile entity comprising the plurality of nested mobile networks, each entry comprising a corresponding mobile entity ingress interface address and a corresponding mobile entity care-of address that are received in the corresponding registration request; and
the predetermined method comprises the steps of:
recursively parsing the binding cache to retrieve a list of ingress interface addresses forming a first path from the mobile entity servicing the node to a root mobile entity, wherein a first ingress interface of the first path comprises an ingress interface address corresponding to the mobile entity servicing the node;
recursively parsing the binding cache to retrieve a list of care-of addresses forming a second path from the root mobile entity to the destination address; and
determining an optimal path based on the first and second paths.

7. The method of claim 6, wherein determining the optimal path based on the first and second paths further comprises the steps of:
truncating the first and second paths such that the first path terminates at an ingress interface address corresponding to a cross-over mobile entity comprising the plurality of nested mobile networks and the second path begins with a first care-of address corresponding to the cross-over mobile entity;
removing the first care-of address from the second path;
removing the first ingress interface address from the first path; and
appending the second path to the first path to form the optimal path.

8. The method of claim 7 further comprising the step of storing the optimal path for enabling autonomous mode routing of a subsequent packet from the node to the destination address.

9. The method of claim 1, wherein the routing information comprising each registration request comprises at least a care-of address and one of a mobile network prefix and a home address for a corresponding mobile entity.

10. The method of claim 1, wherein the step of announcing a root mobile entity address comprises communicating a router announcement comprising a root mobile router announcement (RMRA) option comprising at least a root mobile router address.

11. The method of claim 10, wherein the RMRA further comprises a next-hop mobile router address.

12. The method of claim 10, wherein the root mobile router address comprises one of:
an address corresponding to an ingress interface;
a root mobile router home address; and
a root mobile router care-of address.

13. The method of claim 1 further comprising the steps of:
receiving a packet comprising a destination address, wherein the packet is generated by a node serviced by a mobile entity comprising the plurality of nested mobile networks; and
upon being unable to determine a path to the destination address using the binding cache, performing at least one of discarding the packet and communicating a destination unreachable notification to the mobile entity servicing the node for enabling alternative routing of the packet by the mobile entity servicing the node.

14. The method of claim 1 further comprising the step of communicating the binding cache to at least a portion of the mobile entities comprising the plurality of nested mobile networks for enabling autonomous mode routing by the at least a portion of the mobile entities using the binding cache.

15. The method of claim 1 further comprising the steps of:
receiving a request from a mobile entity comprising the plurality of nested mobile networks to determine a path from the requesting mobile entity to a destination address;
determining a path from the requesting mobile entity to the destination address using the binding cache; and
communicating the determined path to the requesting mobile entity for enabling autonomous mode routing of a packet by the requesting mobile entity to the destination address using one of multiple encapsulation and a single encapsulation comprising a routing header.

16. Apparatus comprising:
a memory storing executable software;
a processor coupled to the memory and executing the software for performing the steps of:
announcing a root mobile entity address;
in response to the announcing, receiving a registration request comprising routing information from each mobile entity in at least a portion of a plurality of mobile entities comprising a plurality of nested mobile networks, wherein at least one of the registration requests is received while in an autonomous mode; and
generating a root mobile entity binding cache using the routing information from the registration requests, for enabling routing within the plurality of nested mobile networks.

17. A method for enabling autonomous mode routing comprising the steps of:
discovering a root mobile entity within a plurality of nested mobile networks;
communicating a registration request comprising routing information to the root mobile entity, for enabling the root mobile entity to generate a root mobile entity binding cache; and
routing a packet comprising a destination address to the root mobile entity for enabling autonomous mode routing of the packet by the root mobile entity to the destination address using the binding cache.

18. The method of claim 17, further comprising the steps of:
receiving a registration request comprising a destination address corresponding to the root mobile entity and further comprising routing information corresponding to a sub-mobile entity;
extracting the routing information corresponding to the sub-mobile entity;
routing the received registration request to the root mobile entity;
generating a second binding cache for enabling autonomous mode routing within the plurality of nested mobile networks;
receiving a packet comprising a destination address;
recursively parsing the second binding cache to determine whether a downstream path can be determined to the destination address;
if the downstream path to the destination address cannot be determined, routing the packet to a next-hop mobile entity on a path to the root mobile entity; and
if the downstream path to the destination address can be determined, performing one of:
routing the packet to the destination address along the downstream path using one of multiple encapsulation and single encapsulation comprising a routing header; and
routing the packet to a first-hop mobile entity in the downstream path.

19. The method of claim 17, wherein discovering the root mobile entity comprises the steps of:
receiving a router announcement comprising at least a root mobile entity address;
extracting the root mobile entity address; and
generating a root mobile entity list corresponding to a plurality of root mobile entities comprising an entry corresponding to each root mobile entity, the entry comprising at least the root mobile entity address.

20. The method of claim 19, wherein the list comprises an entry corresponding to each of the plurality of root mobile entities, the method further comprising, for at least a portion of the plurality of root mobile entities, the steps of:
receiving at least one reachable prefix, each reachable prefix corresponding to at least one other mobile entity within the plurality of nested mobile networks; and
modifying the entry to include the at least one reachable prefix, for enabling selecting one of the plurality of root mobile entities for routing a packet within the plurality of nested mobile networks.
